(19) United States
(12) Patent Application Publication
(10) Pub. No.: US 2026/0222918 A1
(43) Pub. Date: Jul. 30, 2026

(54) INTER-CELL CHANNEL INFORMATION ACQUISITION

(71) Applicant: Telefonaktiebolaget LM Ericsson (publ), Stockholm (SE)

(72) Inventors: Anders FURUSKÄR, Stockholm (SE); Simon JÄRMYR, Skarpnack (SE); Niklas JALDÉN, Enkoping (SE)

(21) Appl. No.: 19/142,449

(22) PCT Filed: Dec. 23, 2022
(86) PCT No.: PCT/SE2022/051238

§ 371 Date: Jun. 23, 2025

(51) Int. Cl. H04W 28/26; H04L 5/00; H04W 52/24; H04W 52/36

(52) U.S. Cl. CPC H04W 28/26; H04L 5/0051; H04W 52/242; H04W 52/367

(57) ABSTRACT

There is provided techniques for inter-cell channel information acquisition of a first cell in an access network. The access network comprises the first cell and a second cell. A method is performed by a network node. The network node serves the first cell. The method comprises obtaining, from a network node serving the second cell, information of transmission resources reserved for uplink reference signal to be transmitted by UEs served by the second cell. The method comprises communicating with the network node serving the second cell for the network node serving the second cell to instruct the UEs served by the second cell to perform a sounding process according to which the uplink reference signals are transmitted by the UEs on the reserved transmission resources. The method comprises estimating channel statistics information for the UEs from the uplink reference signals as received from the UEs on the reserved transmission resources alone. The method comprises storing the channel statistics information.

### TECHNICAL FIELD

Embodiments presented herein relate to a method, a network node, a computer program, and a computer program product for inter-cell channel information acquisition of a first cell in an access network. Embodiments presented herein further relate to a method, a user equipment, a computer program, and a computer program product for assisting in the inter-cell channel information acquisition in the access network.

### BACKGROUND

In many parts of the world, the currently available frequency bands, at current deployment grids, will be sufficient for the coming 5 to 10 years, assuming that the traffic increase follows current trends and that no disruptive technology that requires substantially higher throughputs arises before that. In 5 to 10 years, network operators will therefore have to densify their networks to meet the growing traffic demands.

Densifying the networks implies deploying more sites (comprising access points, or the like). However, the more sites that are deployed, the higher the interference levels are expected to be. Already today the operation of some cells is capacity-limited, due to the amount of inter-cell interference occurring during the data peak hours of the day.

In some examples, the new sites will be provided as small cells, such as picocells or microcells. Although deployment of such small cells in areas with already existing macro cells, sometimes referred to as hetnets, has been studied, actual deployments are rare. One reason for this is that the small cell uptake (i.e., the fraction of user equipment (UEs) served by the small cell compared to the surrounding macro cells) is rather low. The low uptake is due to several reasons, where lower transmit power in the small cell and interference from surrounding macro cells are two reasons.

In further detail, the small cell uptake has traditionally been controlled by, for example, balancing the cell selection offset (CSO) between macro cells and small cells. However, the more the CSO is changed to increase the small cell uptake, the higher the average interference for cell edge UEs become as nothing is done to decrease the transmit power in the macro cells towards the CSO-expanded small cell coverage region. This will be illustrated next with reference to FIG. 1.

FIG. 1 is a schematic diagram illustrating an access network 100 where embodiments presented herein can be applied. The access network 100 comprises network nodes 200-1, 200-2, 400-1. Each of network nodes 200-1, 200-2 provide network access to users, as represented by UE 300-1, 300-2, in a respective first cell 500-1, 500-2. In some examples the first cells 500-1, 500-2 are macro cells. Network node 400-1 provides network access to users, as represented by UE 300-3, in a second cell 600-1. In some examples, the second cell 600-1 is a small cell, such as a micro cell or a pico cell. Each of the network nodes 200-1, 200-2, 400-1 could be any of a radio access network node, radio base station, base transceiver station, node B, evolved node B, access point, access node. Each of the UEs 300-1, 300-2, 300-3 could be any of a portable wireless device, mobile station, mobile phone, handset, wireless local loop phone, user equipment (UE), smartphone, laptop computer, tablet computer, wireless modem, wireless sensor device.

The access network 100 thus represents a scenario where are three cells (for example two macro cells and one small cell) and one user is served in each cell. If each user is transmitting an uplink reference signal, with power adaptation target proportional to the path loss to the serving network node, UE 300-2 will be visible for network node 200-1 and hence benefit from interference mitigation as performed by network node 200-1. This is the case since UE 300-2 is far from its serving network node 200-2 and therefore, according to the power adaptation target, uses a high output power. However, UE 300-3 will be drowned in noise (and hence be non-visible) as seen from network node 200-1. This is the case since UE 300-3 is close to its serving network node 400-1 and therefore, according to the power adaptation target, uses a low output power. Hence, UE 300-3 will not benefit from any interference mitigation as performed by network node 200-1. It could even be that that interference mitigation performed by network node 200-1 with respect to UE 300-2 will increase the average interference towards UE 300-3, hence aggravating the already poor situation for UE 300-3.

### SUMMARY

A general object of embodiments herein is to address the above issues.

In some aspects, the above issues are due to that current channel information acquisition procedures are not suitable for the scenario disclosed with reference to FIG. 1. One particular object of embodiments herein is therefore to provide channel information acquisition procedures that are suitable for scenarios as disclosed with reference to FIG. 1.

According to a first aspect there is presented a method for inter-cell channel information acquisition of a first cell in an access network. The access network comprises the first cell and a second cell. The method is performed by a network node. The network node serves the first cell. The method comprises obtaining, from a network node serving the second cell, information of transmission resources reserved for uplink reference signal to be transmitted by UEs served by the second cell. The method comprises communicating with the network node serving the second cell for the network node serving the second cell to instruct the UEs served by the second cell to perform a sounding process according to which the uplink reference signals are transmitted by the UEs on the reserved transmission resources. The method comprises estimating channel statistics information for the UEs from the uplink reference signals as received from the UEs on the reserved transmission resources alone. The method comprises storing the channel statistics information.

According to a second aspect there is presented a network node for inter-cell channel information acquisition of a first cell in an access network. The access network comprises the first cell and a second cell. The network node comprises processing circuitry. The processing circuitry is configured to cause the network node to obtain, from a network node serving the second cell, information of transmission resources reserved for uplink reference signal to be transmitted by UEs served by the second cell. The processing circuitry is configured to cause the network node to communicate with the network node serving the second cell for the network node serving the second cell to instruct the UEs served by the second cell to perform a sounding process according to which the uplink reference signals are transmitted by the UEs on the reserved transmission resources. The processing circuitry is configured to cause the network node to estimate channel statistics information for the UEs from the uplink reference signals as received from the UEs on the reserved transmission resources alone. The processing circuitry is configured to cause the network node to store the channel statistics information.

According to a third aspect there is presented a network node for inter-cell channel information acquisition of a first cell in an access network. The access network comprises the first cell and a second cell. The network node comprises an obtain module configured to obtain, from a network node serving the second cell, information of transmission resources reserved for uplink reference signal to be transmitted by UEs served by the second cell. The network node comprises a communication module configured to communicate with the network node serving the second cell for the network node serving the second cell to instruct the UEs served by the second cell to perform a sounding process according to which the uplink reference signals are transmitted by the UEs on the reserved transmission resources. The network node comprises an estimate module configured to estimate channel statistics information for the UEs from the uplink reference signals as received from the UEs on the reserved transmission resources alone. The network node comprises a store module configured to store the channel statistics information.

According to a fourth aspect there is presented a computer program for inter-cell channel information acquisition of a first cell in an access network. The computer program comprises computer code which, when run on processing circuitry of a network node, causes the network node to perform actions. One action comprises the network node to reserve transmission resources for uplink reference signal to be transmitted by UEs served by the second cell. One action comprises the network node to provide instructions towards the UEs served by the second cell to perform a sounding process according to which the uplink reference signals are transmitted by the UEs on the reserved transmission resources. One action comprises the network node to estimate channel statistics information for the UEs from the uplink reference signals as received from the UEs on the reserved transmission resources alone. One action comprises the network node to store the channel statistics information.

According to a fifth aspect there is presented a method for assisting in inter-cell channel information acquisition in an access network. The access network comprises the first cell and a second cell. The method is performed by a UE. The UE is served by the second cell. The method comprises receiving information of reserved transmission resources and instructions from the network node to perform a sounding process comprises transmitting uplink reference signals on the reserved transmission resources. The method comprises transmitting the uplink reference signals on the reserved transmission resources for assisting in the inter-cell channel information acquisition.

According to a sixth aspect there is presented a UE, for assisting in inter-cell channel information acquisition in an access network. The access network comprises the first cell and a second cell. The UE comprises processing circuitry. The processing circuitry is configured to cause the UE to, when the UE is served by the second cell, receive information of reserved transmission resources and instructions from the network node to perform a sounding process comprises transmitting uplink reference signals on the reserved transmission resources. The processing circuitry is configured to cause the UE to, when the UE is served by the second cell, transmit the uplink reference signals on the reserved transmission resources for assisting in the inter-cell channel information acquisition.

According to a seventh aspect there is presented a UE, for assisting in inter-cell channel information acquisition in an access network. The access network comprises the first cell and a second cell. The UE comprises a receive module configured to receive, when the UE is served by the second cell, information of reserved transmission resources and instructions from the network node to perform a sounding process comprises transmitting uplink reference signals on the reserved transmission resources. The UE comprises a transmit module configured to transmit, when the UE is served by the second cell. The uplink reference signals on the reserved transmission resources for assisting in the inter-cell channel information acquisition.

According to an eighth aspect there is presented a computer program for assisting in inter-cell channel information acquisition in an access network. The computer program comprises computer code which, when run on processing circuitry of a UE, causes the UE to perform actions. One action comprises the UE to, when the UE is served by the second cell, information of reserved transmission resources and instructions from the network node to perform a sounding process comprises transmitting uplink reference signals on the reserved transmission resources. One action comprises the UE to, when the UE is served by the second cell. The uplink reference signals on the reserved transmission resources for assisting in the inter-cell channel information acquisition.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects enable efficient acquisition of channel information and hence are therefore suitable for scenarios as disclosed with reference to FIG. 1.

Advantageously, these aspects can be used to improve downlink interference suppression.

Advantageously, these aspects can thereby be used to increase the signal to interference plus noise ratio (SINR) for the UEs served by the second cell. In turn, this improves data rates, decreases overall transmission times, and decreases the interference generated from the first cell to the second cell.

Advantageously, these aspects can thereby be used to decreases the transmission time in the second cell, which in turn improves network energy efficiency.

Advantageously, these aspects can thereby be used to save battery in UEs served in the second cell.

Advantageously, these aspects can thereby be used to improve the overall capacity in the network.

Advantageously, these aspects can thereby be used to improve the benefits of deploying one or more second cells.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise.

The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating an access network according to embodiments;

FIGS. 2 and 3 are flowcharts of methods according to embodiments;

FIG. 4 is a schematic diagram showing functional units of a network node according to an embodiment;

FIG. 5 is a schematic diagram showing functional modules of a network node according to an embodiment;

FIG. 6 is a schematic diagram showing functional units of a UE according to an embodiment;

FIG. 7 is a schematic diagram showing functional modules of a UE according to an embodiment; and

FIG. 8 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

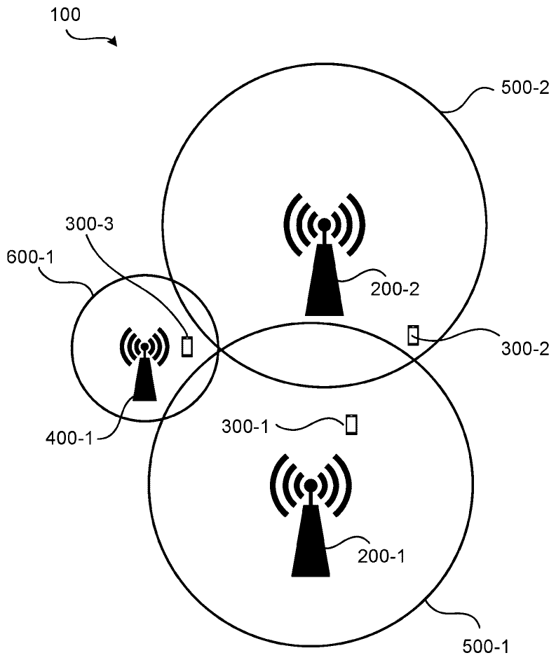

As disclosed above, current channel information acquisition procedures are not suitable for the scenario disclosed with reference to FIG. 1. It is here noted that although just three UEs 300-1, 300-2, 300-3 are illustrated in FIG. 1, each UE 300-1, 300-2, 300-3 might represent a plurality of UEs in each cell 500-1, 500-2, 600-1.

The embodiments disclosed herein therefore relate to techniques for inter-cell channel information acquisition of a first cell in an access network 100 and for assisting in such inter-cell channel information acquisition in the access network 100. In order to obtain such techniques, there is provided a network node 200-1, a method performed by the network node 200-1, a computer program product comprising code, for example in the form of a computer program, that when run on processing circuitry of the network node 200-1, causes the network node 200-1 to perform the method. In order to obtain such techniques, there is further provided a UE 300-3, a method performed by the UE 300-3, and a computer program product comprising code, for example in the form of a computer program, that when run on processing circuitry of the UE 300-3, causes the UE 300-3 to perform the method.

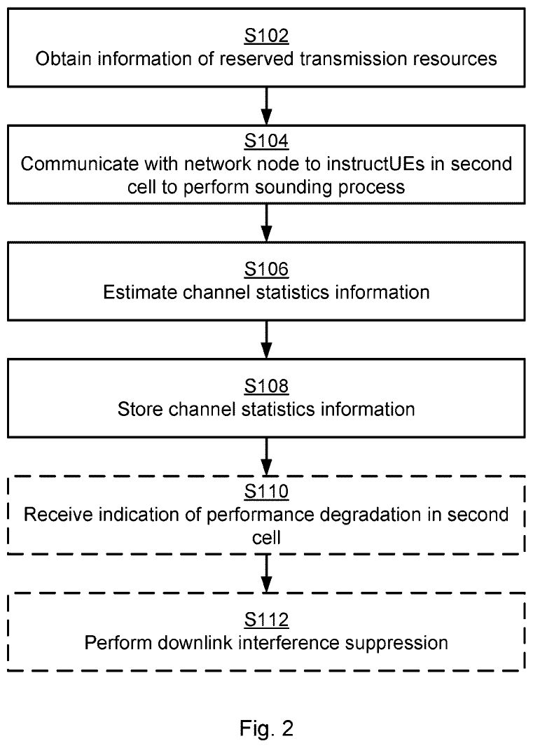

Reference is now made to FIG. 2 illustrating a method for inter-cell channel information acquisition of a first cell 500-1 in an access network 100 as performed by network node 200-1 according to an embodiment. The access network 100 comprises the first cell 500-1 and a second cell 600-1. Network node 200-1 serves the first cell 500-1. Network node 400-1 serves the second cell 600-1.

S102: Network node 200-1 obtains, from network node 400-1, information of transmission resources reserved for uplink reference signal to be transmitted by UEs 300-3 served by the second cell 600-1 to assist network node 200-1 to acquire inter-cell channel information.

S104: Network node 200-1 communicates with network node 400-1 for network node 400-1 to instruct the UEs 300-3 served by the second cell 600-1 to perform a sounding process. According to the sounding process, the uplink reference signals are to be transmitted by the UEs 300-3 on the reserved transmission resources.

It is here assumed, as will be further disclosed in S206, that the UEs 300-3 act in accordance with the instructions and thus transmits the uplink reference signals on the reserved transmission resources for assisting in the inter-cell channel information acquisition. It is further assumed that network node 200-1 receives the uplink reference signals.

S106: Network node 200-1 estimates channel statistics information for the UEs 300-3 from the uplink reference signals as received from the UEs 300-3 on the reserved transmission resources alone.

S108: Network node 200-1 stores the channel statistics information.

The channel statistics information might be represented by an interference covariance matrix. The collected channel statistics information might be stored either in a local database or in a distributed database.

In some examples, the first cell 500-1 is a macro cell and the second cell 600-1 is a picocell or a microcell.

Embodiments relating to further details of inter-cell channel information acquisition of a first cell 500-1 in an access network 100 as performed by network node 200-1 will now be disclosed with continued reference to FIG. 1 and FIG. 2.

In some aspects, the UEs 300-3 served by the second cell 600-1 are to perform the sounding process when the network experience low or medium load. One reason for this is that then there is a higher probability of uplink reference signal resources being available for inter-cell interference gathering purposes than when the network experiences high load. Therefore, in some examples, at least one of the network nodes 200-1, 400-1 regularly obtains information of the current network load in the network. Such information can be provided from a management node in the network.

In some aspects, one or more uplink reference signal transmission combs, orthogonal frequency-division multiplexing (OFDM) symbols, and/or cyclic shifts are reserved for use by UEs 300-3 served in the second cell 600-1. Network node 400-1 in the second cell 600-1 can then instruct its served UEs 300-3 to perform a sounding process on the specific allocated transmission comb. In some aspects, the management node informs network node 400-1 of which uplink reference signal transmission comb UE 300-3 is to use for the sounding process. It is implicitly understood that network node 200-1 is also made aware of this information. Further, network node 200-1 might either from the management node or directly from network node 400-1 obtain information of the cell ID for the second cell 600-1, which network node 200-1 may use for tagging the estimated channel statistics information. This can simplify the retrieval of relevant channel statistics information when needed (e.g., for interference suppression purposes). That is, in some embodiments, the second cell 600-1 has an identifier, and the identifier of the second cell 600-1 is stored with the channel statistics information.

This sounding process is performed even though network node 400-1 might be configured such that it is not relying on reception of reference signals from its served UEs 300-3 for channel state acquisition. The intent of the sounding process is only for network nodes in neighboring cells (i.e., network node 200-1) to detect UEs 300-3 served in the second cell 600-1. Network node 200-1 is therefore configured to listen and create, or estimate, channel statistics information for the reserved transmission comb alone.

In some embodiments, the UEs 300-3 are further instructed to perform power control on the reserved transmission resources. Aspects of this power control of the uplink reference signals will be disclosed next. Information relating to the power control to be applied at UE 300-3 can be reported by network node 200-1 to network node 400-1, for further distribution to UE 300-3, either directly or indirectly via the management node.

In some aspects, during the sounding procedure, the power control is adapted such that the transmit power for UE 300-3 is appropriate for this UE 300-3 to be heard by network node 200-1. This could imply that the power control threshold for the sounding process for UE 300-3 is set to be higher than typical uplink transmissions intended for being received by network node 400-1 in the second cell 600-1. Thus, in some embodiments, the power control comprises the UEs 300-3 to set a power threshold for the reserved transmission resources to be higher than when communicating with network node 400-1 serving the second cell 600-1.

In some aspects, UE 300-3 is configured to perform the sounding process at maximum allowed transmit power. That is, in some embodiments, the power control comprises the UEs 300-3 to use a maximum available transmission power for the reserved transmission resources.

In some aspects, UE 300-3 is configured according to the average transmit power for UEs at the cell edge in the first cell 500-1. That is, in some embodiments, the power control comprises the UEs 300-3 to set a power threshold for the reserved transmission resources to be equal to a power level of cell edge UEs served by the first cell 500-1.

In some aspects, in case there is more than one second cell 600-1, the procedure disclosed thus far can be iteratively performed for UEs served in each such second cell, one second cell at a time. Particularly, in some embodiments, when the access network 100 comprises N second cells, the obtaining in S102, the interacting in S104, the estimating in S106, and the storing in S108 is iteratively performed for each of the N second cells. One purpose of this is to individually estimate the channel statistics information for the UEs served by each of the N second cell. That is, this allow for UEs served in all second cells to be individually detectable by network node 200-1. Interference suppression in the downlink as performed by network node 200-1 may then be individually controlled per each second cell.

As already mentioned, the estimated channel statistics information can be used for downlink interference suppression purposes. In particular, in some embodiments, network node 200-1 is configured to perform (optional) step S112.

S112: Network node 200-1 performs downlink interference suppression by using a precoder P determined as a function of the interference covariance matrix.

For this purpose, network node 200-1 retrieves the previously collected channel statistics for the second cell 600-1 and uses this when calculating a downlink transmission precoder.

Further aspects of downlink interference suppression as performed by network node 200-1 will now be disclosed.

In some aspects, the downlink interference suppression is performed when performance degradation is experienced in the network. Particularly, in some embodiments, network node 200-1 is configured to perform (optional) step S110.

S110: Network node 200-1 receives an indication originating from network node 400-1 serving the second cell 600-1 of performance degradation in the second cell 600-1. The downlink interference suppression can then be performed in response thereto.

That is, network node 200-1 might retrieve the previously stored channel statistics information and use this information when calculating the downlink transmission precoder as in S112 in response to having received the indication in S110.

In some examples, the precoder P is determined as:

$$P = {( {H}^{H} H + R )}^{- 1} {H}^{H} ,$$

where H represents a channel between network node 200-1 and UEs 300-1 served by the first cell 500-1, where R represents interference covariance information, where X⁻¹ represents inverse of matrix X, and where Y^{H} represents Hermitian transpose of matrix Y.

A precoder P determined according to this expression could be used to achieve maximizing beamforming gain towards served UEs 300-1, subject to minimizing interference towards UEs 300-3 (and UEs 300-2).

The precoder P could also be determined in other ways. For example, the above expression for the determining of the precoder P does not include that some of the terms in the expression are scaled, or weighted. For example, the matrix R representing the interference covariance information might contain a regularization term (a scaled identity matrix). In still further examples, the precoder P is determined in accordance with a reduced-complexity formulation:

$$P = {R}^{- 1} {{H}^{H} ( H {R}^{- 1} {H}^{H} + I )}^{- 1} ,$$

where I is the identity matrix.

In some examples, the interference covariance information R comprises the interference covariance matrix, i.e., the interference covariance matrix representing the second cell 600-1. In some examples, the interference covariance information is a linear combination of an interference covariance matrix for the first cell 500-2, i.e., representative of UEs 300-2, and the interference covariance matrix for the second cell 600-1. Particularly, in some embodiments, the interference covariance information is defined as:

$$R = {α}_{1} {R}_{1} + {α}_{2} {R}_{2} ,$$

where R₁ is the interference covariance matrix for the first cell 500-1, where R₂ is the interference covariance matrix for the second cell 600-1, and where a₁ and a₂ are scale factors.

Further, in case the access network 100 comprises N second cells 600-1, the interference covariance matrix for all the second cells 600-1 might be a linear combination of interference covariance matrices for UEs 300-3 served by the N second cells 600-1. Particularly, in some embodiments, the interference covariance matrix R₂ for all the second cells 600-1 is defined as:

$${R}_{2} = {β}_{1} {R}_{21} + {β}_{2} {R}_{22} + … + {β}_{N} {R}_{2 N} ,$$

where, for n=1, . . . , N, R₂ₙ is the interference covariance matrix for UEs 300-3 served by second cell n, and Bn are scale factors. The interference covariance matrix R₂ could thus be built up by appropriate scaled versions of multiple second cell covariance matrices, as obtained for several UEs in the second cells 600-1.

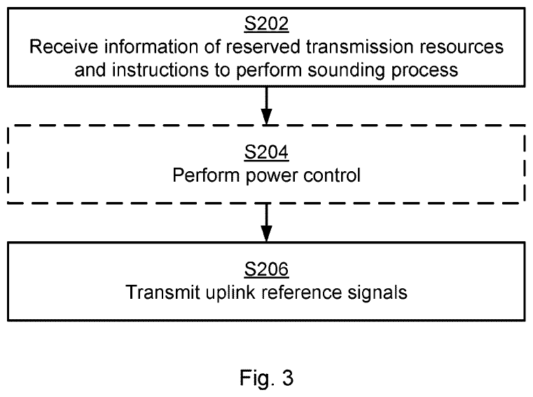

Reference is now made to FIG. 3 illustrating a method for assisting in inter-cell channel information acquisition in an access network 100 as performed by UE 300-3 according to an embodiment. The access network 100 comprises the first cell 500-1 and a second cell 600-1. UE 300-3 is served by the second cell 600-1.

As disclosed above, network node 200-1 in S102 obtains, from network node 400-1, information of transmission resources reserved for uplink reference signal to be transmitted by UEs 300-3 served by the second cell 600-1 to assist network node 200-1 to acquire inter-cell channel information. It is assumed that network node 400-1 has reserved these transmission resources, that network node 400-1 instructs UEs 300-3 to perform a sounding process, and that these instructions reach UE 300-3 via network node 400-1.

S202: UE 300-3 receives information of reserved transmission resources and instructions from network node 400-1 to perform a sounding process comprising transmitting uplink reference signals on the reserved transmission resources.

UE 300-3 then performs the sounding process in accordance with the received instructions.

S206: UE 300-3 transmits the uplink reference signals on the reserved transmission resources for assisting in the inter-cell channel information acquisition.

As above, in some examples, the first cell 500-1 is a macro cell and the second cell 600-1 is a picocell or a microcell.

Embodiments relating to further details of assisting in inter-cell channel information acquisition in an access network 100 as performed by UE 300-3 will now be disclosed with continued reference to FIG. 1 and FIG. 3.

As disclosed above, in some embodiments, UE 300-3 is further instructed to perform power control on the reserved transmission resources. Hence, in some embodiments, UE 300-3 is configured to perform (optional) step S204.

S204: UE 300-3 performs power control on the reserved transmission resources.

One purpose of performing the power control is for UE 300-3 to adapt transmission power of the uplink reference signals differently than transmission power of uplink reference signals transmitted for assisting in intra-cell channel information acquisition in the second cell 600-1.

In some aspects, the power control is based on pathloss estimates. For example, UE 300-3 might estimate the pathloss which gives the minimum transmission power that UE 300-3 must use for UE 300-3 to be heard in the first cell 500-1 by network node 200-1. Therefore, in some embodiments, performing the power control involves UE 300-1 to select a minimum transmission power based on a pathloss estimated to the first cell 500-1. For example, the transmission power might be set as a combination of the pathloss to its own cell (i.e., the second cell 600-1) and the pathloss in the strongest neighbor cell (i.e., the first cell 500-1). Therefore, in some embodiments, performing the power control involves selecting a minimum transmission power further based on a pathloss estimated to the second cell 600-1. For example, UE 300-3 might set a power control threshold for the sounding process to be higher than any typical uplink transmissions intended to be received by second cell 600-1. Therefore, in some embodiments, the power control comprises UE 300-3 to set a power threshold for the reserved transmission resources to be higher than when communicating with network node 400-1 serving the second cell 600-1.

In some aspects, UE 300-3 is configured to perform the sounding process at maximum allowed transmit power. That is, in some embodiments, the power control comprises UE 300-3 to use a maximum available transmission power for the reserved transmission resources.

As disclosed above, in some aspects, during the sounding procedure, the power control is adapted such that the transmit power for UE 300-3 is appropriate for this UE 300-3 to be heard by network node 200-1, and in some aspects, the power control is adapted according to the average transmit power for UEs at the cell edge in the first cell 500-1. This requires network node 200-1 to provide information of the power control towards UE 300-3. As above, the information provided by network node 200-1 towards UE 300-3 is forwarded via network node 400-1 to UE 300-3. Therefore, in some embodiments, UE 300-3 is instructed by network node 400-1 to perform the power control on the reserved transmission resources. This could be the case where the power control comprises a power threshold for the reserved transmission resources.

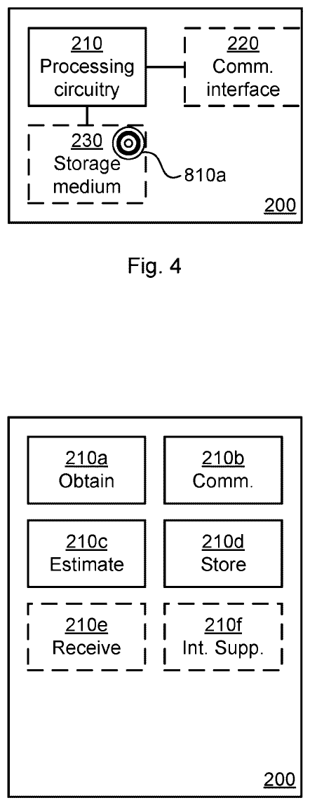

FIG. 4 schematically illustrates, in terms of a number of functional units, the components of a network node 200-1 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 810a (as in FIG. 8), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200-1 to perform a set of operations, or steps, as disclosed above. For example, the storage medium 230 may store the set of operations, and the processing circuitry 210 may be configured to retrieve the set of operations from the storage medium 230 to cause the network node 200-1 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The network node 200-1 may further comprise a communications (comm.) interface 220 for communications with other entities, functions, nodes, and devices, such as another network node 200-2, 400-1, and UEs 300-1, 300-2, 300-3 either directly or indirectly. As such the communications interface 220 may comprise one or more transmitters and receivers, comprising analogue and digital components.

The processing circuitry 210 controls the general operation of the network node 200-1 e.g. by sending data and control signals to the communications interface 220 and the storage medium 230, by receiving data and reports from the communications interface 220, and by retrieving data and instructions from the storage medium 230. Other components, as well as the related functionality, of the network node 200-1 are omitted in order not to obscure the concepts presented herein.

FIG. 5 schematically illustrates, in terms of a number of functional modules, the components of a network node 200-1 according to an embodiment. The network node 200-1 of FIG. 5 comprises a number of functional modules; an obtain module 210a configured to perform step S102, a communicate (Comm.) module 210b configured to perform step S104, an estimate module 210c configured to perform step S106, and a store module 210d configured to perform step S108. The network node 200-1 of FIG. 5 may further comprise a number of optional functional modules, such as any of a receive module 210e configured to perform step S110, and an interference suppression (Int. Supp.) module 21of configured to perform step S112. In general terms, each functional module 210a: 21of may be implemented in hardware or in software. Preferably, one or more or all functional modules 210a: 21of may be implemented by the processing circuitry 210, possibly in cooperation with the communications interface 220 and/or the storage medium 230. The processing circuitry 210 may thus be arranged to from the storage medium 230 fetch instructions as provided by a functional module 210a: 210f and to execute these instructions, thereby performing any steps of the network node 200-1 as disclosed herein.

The network node 200-1 may be provided as a standalone device or as a part of at least one further device. Alternatively, functionality of the network node 200-1 may be distributed between at least two devices, or nodes. Thus, a first portion of the instructions performed by the network node 200-1 may be executed in a first device, and a second portion of the instructions performed by the network node 200-1 may be executed in a second device; the herein disclosed embodiments are not limited to any particular number of devices on which the instructions performed by the network node 200-1 may be executed. Hence, the methods according to the herein disclosed embodiments are suitable to be performed by a network node 200-1 residing in a cloud computational environment. Therefore, although a single processing circuitry 210 is illustrated in FIG. 4 the processing circuitry 210 may be distributed among a plurality of devices, or nodes. The same applies to the functional modules 210a: 210f of FIG. 5 and the computer program 820a of FIG. 8.

Some (radio) access network architectures defines network nodes (or gNBs) comprising multiple component parts or nodes: a central unit (CU), one or more distributed units (DUs), and one or more radio units (RUs). The protocol layer stack of the network node is divided between the CU, the DUs and the RUs, with one or more lower layers of the stack implemented in the RUs, and one or more higher layers of the stack implemented in the CU and/or DUs. The CU is coupled to the DUS via a fronthaul higher layer split (HLS) network; the CU/DUs are connected to the RUs via a fronthaul lower-layer split (LLS) network. The DU may be combined with the CU in some embodiments, where a combined DU/CU may be referred to as a CU or simply a baseband unit. A communication link for communication of user data messages or packets between the RU and the baseband unit, CU, or DU is referred to as a fronthaul network or interface. Messages or packets may be transmitted from the network node 200 in the downlink (i.e., from the CU to the RU) or received by the network node 200 in the uplink (i.e., from the RU to the CU).

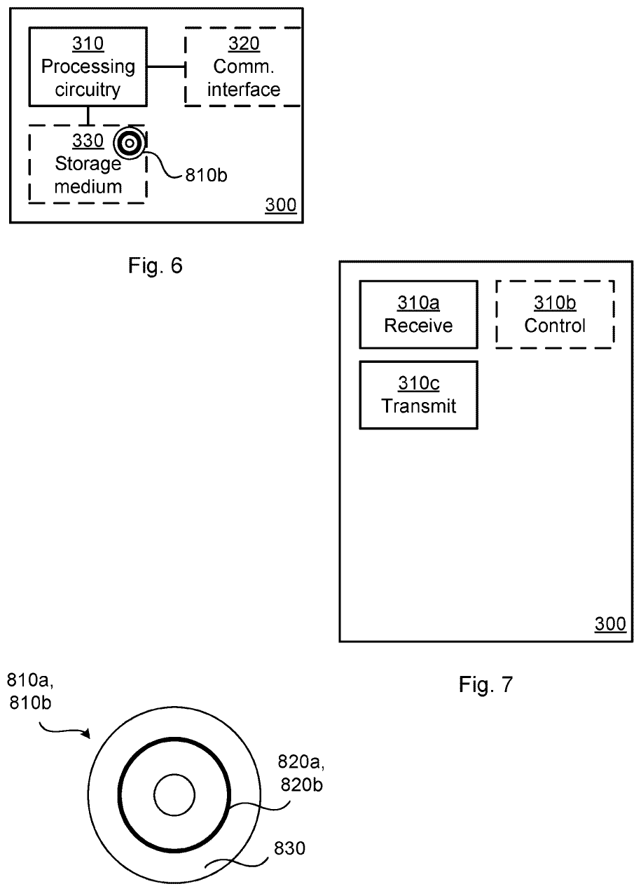

FIG. 6 schematically illustrates, in terms of a number of functional units, the components of a UE 300-3 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 810b (as in FIG. 8), e.g. in the form of a storage medium 330. The processing circuitry 310 may further be provided as at least one application specific integrated circuit (ASIC), or field programmable gate array (FPGA).

Particularly, the processing circuitry 310 is configured to cause the UE 300-3 to perform a set of operations, or steps, as disclosed above. For example, the storage medium 330 may store the set of operations, and the processing circuitry 310 may be configured to retrieve the set of operations from the storage medium 330 to cause the UE 300-3 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The UE 300-3 may further comprise a communications interface 320 for communications with other entities, functions, nodes, and devices, such as the network nodes 200-1, 200-2, 400-1 either directly or indirectly. As such the communications interface 320 may comprise one or more transmitters and receivers, comprising analogue and digital components.

The processing circuitry 310 controls the general operation of the UE 300-3 e.g. by sending data and control signals to the communications interface 320 and the storage medium 330, by receiving data and reports from the communications interface 320, and by retrieving data and instructions from the storage medium 330. Other components, as well as the related functionality, of the UE 300-3 are omitted in order not to obscure the concepts presented herein.

FIG. 7 schematically illustrates, in terms of a number of functional modules, the components of a UE 300-3 according to an embodiment. The UE 300-3 of FIG. 7 comprises a number of functional modules; a receive module 310a configured to perform step S202, and a transmit module 310c configured to perform step S206.

The UE 300-3 of FIG. 7 may further comprise a number of optional functional modules, such as a control module 310b configured to perform step S204. In general terms, each functional module 310a: 310c may be implemented in hardware or in software. Preferably, one or more or all functional modules 310a: 310c may be implemented by the processing circuitry 310, possibly in cooperation with the communications interface 320 and/or the storage medium 330. The processing circuitry 310 may thus be arranged to from the storage medium 330 fetch instructions as provided by a functional module 310a: 310c and to execute these instructions, thereby performing any steps of the UE 300-3 as disclosed herein.

FIG. 8 shows one example of a computer program product 810a, 810b comprising computer readable means 830. On this computer readable means 830, a computer program 820a can be stored, which computer program 820a can cause the processing circuitry 210 and thereto operatively coupled entities and devices, such as the communications interface 220 and the storage medium 230, to execute methods according to embodiments described herein. The computer program 820a and/or computer program product 810a may thus provide means for performing any steps of the network node 200-1 as herein disclosed. On this computer readable means 830, a computer program 820b can be stored, which computer program 820b can cause the processing circuitry 310 and thereto operatively coupled entities and devices, such as the communications interface 320 and the storage medium 330, to execute methods according to embodiments described herein. The computer program 820b and/or computer program product 810b may thus provide means for performing any steps of the UE 300-3 as herein disclosed.

In the example of FIG. 8, the computer program product 810a, 810b is illustrated as an optical disc, such as a CD (compact disc) or a DVD (digital versatile disc) or a Blu-Ray disc. The computer program product 810a, 810b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 820a, 820b is here schematically shown as a track on the depicted optical disk, the computer program 820a, 820b can be stored in any way which is suitable for the computer program product 810a, 810b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A network node for inter-cell channel information acquisition of a first cell in an access network, wherein the access network comprises the first cell and a second cell, the network node comprising processing circuitry, the processing circuitry being configured to cause the network node to:
obtain, from a network node serving the second cell, information of transmission resources reserved for uplink reference signal to be transmitted by user equipment, UEs, served by the second cell;
communicate with the network node serving the second cell for the network node serving the second cell to instruct the UEs served by the second cell to perform a sounding process according to which of the uplink reference signals are transmitted by the UEs on the reserved transmission resources;
estimate channel statistics information for the UEs from the uplink reference signals as received from the UEs on the reserved transmission resources alone; and
store the channel statistics information.

2. The network node according to claim 1, the processing circuitry being configured to cause the network node to:
instruct the UEs to perform power control on the reserved transmission resources.

3. The network node according to claim 2, wherein the power control comprises the UEs to set a power threshold for the reserved transmission resources to be higher than when communicating with a network node serving the second cell.

4. The network node according to claim 2, wherein the power control comprises the UEs to use a maximum available transmission power for the reserved transmission resources.

5. The network node according to claim 2, wherein the power control comprises the UEs to set a power threshold for the reserved transmission resources to be equal to a power level of cell edge UEs served by the first cell.

6. The network node according to claim 1, wherein the second cell has an identifier, and wherein the identifier of the second cell is stored with the channel statistics information.

7. The network node according to claim 1, wherein the access network comprises N second cells, and wherein said obtaining, said communicating, said estimating, and said storing is iteratively performed for each of the N second cells for thereby individually estimating the channel statistics information for the UEs served by each of the N second cells.

8. The network node according to claim 1, wherein the channel statistics information is represented by an interference covariance matrix, and wherein the processing circuitry further being configured to cause the network node to:
perform downlink interference suppression by using a precoder P determined as a function of the interference covariance matrix;
receive an indication originating from the network node serving the second cell of performance degradation in the second cell, and wherein the downlink interference suppression is performed in response thereto.

9-10. (canceled)

11. The network node according to claim 8, wherein the precoder P is determined as:
$$P = {( {H}^{H} H + R )}^{- 1} {H}^{H}$$
where H represents a channel between the network node and UEs served by the first cell, where R represents interference covariance information, where X⁻¹ represents inverse of matrix X, and where Y^{H} represents Hermitian transpose of matrix Y.

12. The network node according to claim 8, wherein the interference covariance information comprises the interference covariance matrix.

13. The network node according to claim 8, wherein the interference covariance information is a linear combination of an interference covariance matrix for another first cell and the interference covariance matrix for the second cell, and wherein the interference covariance information is defined as:
$$R = {α}_{1} {R}_{1} + {α}_{2} {R}_{2}$$
where R₁ is the interference covariance matrix for the first cell, where R₂ is the interference covariance matrix for the second cell, and where a₁ and a₂ are scale factors.

14. (canceled)

15. The network node according to claim 8, wherein the access network comprises N second cells, wherein the interference covariance matrix for all the second cells is a linear combination of interference covariance matrices for UEs served by the N second cells, and wherein the interference covariance matrix R₂ for all the second cells is defined as:
$${R}_{2} = {β}_{1} {R}_{21} + {β}_{2} {R}_{22} + … + {β}_{N} {R}_{2 N}$$
where, for n=1, . . . , N, R₂, is the interference covariance matrix for UEs served by second cell n, and βₙ are scale factors.

16. (canceled)

17. A user equipment, UE, for assisting in inter-cell channel information acquisition in an access network, wherein the access network comprises the first cell and a second cell, the UE comprising processing circuitry, the processing circuitry being configured to cause the UE to, when the UE is served by the second cell:
receive information of reserved transmission resources and instructions from the network node to perform a sounding process comprising transmitting uplink reference signals on the reserved transmission resources; and
transmit the uplink reference signals on the reserved transmission resources for assisting in the inter-cell channel information acquisition.

18. The UE according to claim 17, the processing circuitry further being configured to cause the UE to:
perform power control on the reserved transmission resources for thereby to adapt transmission power of the uplink reference signals differently than transmission power of uplink reference signals transmitted for assisting in intra-cell channel information acquisition in the second cell.

19. The UE according to claim 18, wherein performing the power control involves selecting a minimum transmission power based on a pathloss estimated to the first cell and a pathloss estimated to the second cell.

20. (canceled)

21. The UE according to claim 18, wherein the power control comprises the UE to set a power threshold for the reserved transmission resources to be higher than when communicating with the network node serving the second cell.

22. (canceled)

23. The UE according to claim 18, wherein the power control comprises a power threshold for the reserved transmission resources.

24. The UE according to claim 18, wherein the UE further is instructed by the network node to perform the power control on the reserved transmission resources.

25. (canceled)

26. A method for inter-cell channel information acquisition of a first cell in an access network, wherein the access network comprises the first cell and a second cell, wherein the method is performed by a network node, wherein the network node serves the first cell, wherein the method comprises:
obtaining, from a network node serving the second cell, information of transmission resources reserved for uplink reference signal to be transmitted by user equipment, UEs, served by the second cell;
communicating with the network node serving the second cell for the network node serving the second cell to instruct the UEs served by the second cell to perform a sounding process according to which the uplink reference signals are transmitted by the UEs on the reserved transmission resources;
estimating channel statistics information for the UEs from the uplink reference signals as received from the UEs on the reserved transmission resources alone; and
storing the channel statistics information.

27. (canceled)

28. A method for assisting in inter-cell channel information acquisition in an access network, wherein the access network comprises the first cell and a second cell, wherein the method is performed by a user equipment, UE, wherein the UE is served by the second cell, wherein the method comprises:
receiving information of reserved transmission resources and instructions from the network node to perform a sounding process comprising transmitting uplink reference signals on the reserved transmission resources; and
transmitting the uplink reference signals on the reserved transmission resources for assisting in the inter-cell channel information acquisition.

29-31. (canceled)
